(19) United States
(12) Patent Application Publication
(10) Pub. No.: US 2024/0221380 A1
(43) Pub. Date: Jul. 4, 2024

(54) APPARATUS AND METHOD FOR AUTOMATICALLY EXTRACTING REGION OF INTEREST IN REAL TIME ADAPTIVE TO CHARACTERISTICS OF BROADCASTING CONTENT

(71) Applicant: Electronics and Telecommunications Research Institute, Daejeon (KR)

(72) Inventors: Da Yun NAM, Daejeon (KR); Seong Yong LIM, Daejeon (KR); Hyun Cheol KIM, Daejeon (KR); Joo Myoung SEOK, Daejeon (KR)

(21) Appl. No.: 18/403,660

(22) Filed: Jan. 3, 2024

(30) Foreign Application Priority Data
Jan. 4, 2023 (KR) 10-2023-0001412

(51) Int. Cl. G06V 20/40; G06T 7/246; G06T 7/60; G06V 10/762; G06V 10/94

(52) U.S. Cl. CPC G06V 20/46; G06T 7/248; G06T 7/60; G06V 10/762; G06V 10/945; G06T 2207/10016; G06T 2207/20092

(57) ABSTRACT

A real-time automatic region of interest extraction method, apparatus, and recording medium adaptive to the broadcast content characteristics of the present disclosure may include confirming whether a region of interest of a current frame is a cluster-centered region of interest or an object-centered region of interest, extracting a tracking-based region of interest of the current frame according to a type of the region of interest, and determining a final region of interest of the current frame based on the extracted tracking-based region of interest of the current frame.

### CROSS-REFERENCE TO RELATED APPLICATIONS

This application claims the benefit of earlier filing date and right of priority to Korean Application No. 10-2023-0001412, filed on Jan. 4, 2023, the contents of which are all hereby incorporated by reference herein in their entirety.

### TECHNICAL FIELD

The present disclosure relates to an apparatus and method for automatically extracting a region of interest so that high-resolution images can be viewed on display terminals of various screen ratios and resolutions.

### BACKGROUND ART

There are many different types of display terminal devices currently on the market, and each terminal device displays images at a specific resolution and screen ratio. For example, the display devices of the latest mobile terminals have various screen ratios such as 2:3, 3:5, 9:16, 10:16, 3:4, 9:19, etc. depending on the manufacturer and device type. Additionally, viewers can rotate the terminal device 90 degrees or use the video playback app's size enlargement or reduction function to readjust the size and screen ratio of the image to suit the viewer's preference. Therefore, the size and screen ratio of the output image must be able to be flexibly changed to reflect the diversity of display terminals and user preferences, and in particular, when the screen ratio of the input image is different from the screen ratio of the output image, a technology that can extract a region of interest with the screen ratio of the output image from the input image is needed.

Many of the prior art techniques require a process of setting an object/region of interest from an user to extract a region of interest. Once an object/region of interest is set, the final region of interest centered on the object/region of interest selected is output through various tracking methods. The above technologies cannot automatically view a region of interest without user manipulation, and it may be difficult to view multiple objects distributed in a large space simultaneously. Recently, technologies that can estimate a region of interest without user manipulation have emerged, and these technologies can show appropriate a region of interest in images containing a small number of objects. For example, by creating a Saliency Map, a region of interest can be set around the region with the highest salience. The region of interest extraction technology tracked based on the saliency map can appropriately find a region of interest when an input image is an image containing a small number of objects. However, there is a tendency to not properly extract regions of interest from images containing many small-sized objects.

Currently, there is a high demand for broadcast video, not only for video with a small number of objects of appropriate size, but also for broadcast video with many objects of very small size, such as sports broadcast video and long-distance concert video. Conventional techniques may work well when there are a small number of large-sized objects in an image, but the region of interest estimation function for images displaying many small objects needs to be improved.

Therefore, an automatic region of interest extraction technique that can estimate an appropriate region of interest despite various broadcast content characteristics is needed.

### DISCLOSURE

### Technical Problem

The present disclosure relates to an apparatus and method that can extract a region of interest corresponding to the output resolution and screen ratio from a high-resolution input image in real time. The purpose of the present disclosure is to provide a method that can adaptively select a region of interest extraction method according to the characteristics of various broadcast contents such as sports, cultural performances, and talk shows, and to extract a visually stable region of interest in real time.

### Technical Solution

A real-time automatic region of interest extraction method, apparatus, and recording medium adaptive to the broadcast content characteristics of the present disclosure may include confirming whether a region of interest of a current frame is a cluster-centered region of interest or an object-centered region of interest, extracting a tracking-based region of interest of the current frame according to a type of the region of interest, and determining a final region of interest of the current frame based on the extracted tracking-based region of interest of the current frame, in response to the type of the region of interest being confirmed as the cluster-centered region of interest, extracting the tracking-based region of interest may be performed for each cluster comprised of multiple objects in the current frame, and in response to the type of the region of interest being confirmed as the object-centered region of interest, extracting the tracking-based region of interest may be performed based on a single object.

In a real-time automatic region of interest extraction method, apparatus, and recording medium adaptive to the broadcast content characteristics of the present disclosure, a center point of the tracking-based region of interest extracted for each cluster may be determined by an average position or median value of multiple objects in a cluster.

In a real-time automatic region of interest extraction method, apparatus, and recording medium adaptive to the broadcast content characteristics of the present disclosure, a width and height of the tracking-based region of interest extracted for each cluster may be determined based on the center point and a radius of the cluster.

In a real-time automatic region of interest extraction method, apparatus, and recording medium adaptive to the broadcast content characteristics of the present disclosure, the determined width and height are adjusted to include all bounding boxes of the multiple objects in the cluster.

In a real-time automatic region of interest extraction method, apparatus, and recording medium adaptive to the broadcast content characteristics of the present disclosure, the radius of the cluster may be set in consideration of an output resolution of an image including the current frame.

In a real-time automatic region of interest extraction method, apparatus, and recording medium adaptive to the broadcast content characteristics of the present disclosure, the single object may be determined differently depending on a type of the current frame.

In a real-time automatic region of interest extraction method, apparatus, and recording medium adaptive to the broadcast content characteristics of the present disclosure, in response to the current frame being an initialization frame, the single object may be determined based on a user-specified signal or a result of multi-object tracking, and in response to the current frame being a frame after the initialization frame, the single object may be determined to be the single object determined in the initialization frame.

In a real-time automatic region of interest extraction method, apparatus, and recording medium adaptive to the broadcast content characteristics of the present disclosure, the initialization frame may be a first frame of a frame sequence including the current frame or a first frame input after the type of the region of interest is changed.

In a real-time automatic region of interest extraction method, apparatus, and recording medium adaptive to the broadcast content characteristics of the present disclosure, the user-specified signal may include a signal that specifies a boundary of the single object through a mouse drag function.

In a real-time automatic region of interest extraction method, apparatus, and recording medium adaptive to the broadcast content characteristics of the present disclosure, a width and height of the tracking-based region of interest extracted based on the single object are set in consideration of an output resolution of an image including the current frame.

### Technical Effects

According to the configuration of the present disclosure, a region of interest in a high-resolution image may be automatically extracted according to a resolution and screen ratio of an output display. The present disclosure has the advantage of allowing a region of interest to be viewed more stably and universally because the region of interest may be selected using an object-centered method or a cluster-centered method according to various broadcast content characteristics and viewer tastes. The present disclosure makes it possible to control region of interest extraction through viewer manipulation and, conversely, to automatically estimate the region of interest in real time even in the absence of viewer intervention.

### DESCRIPTION OF DRAWINGS

FIG. 1 is a diagram illustrating a device that automatically extracts a region of interest from a captured high-resolution image according to a resolution and screen ratio of a display device.

FIG. 2 is a diagram illustrating a region of interest extraction unit.

FIG. 3 is a diagram illustrating an embodiment according to the process of FIG. 2.

FIG. 4 is a diagram illustrating a cluster-centered region of interest estimation unit.

FIG. 5 is an example diagram of a result of clustering multiple objects in a cluster detection unit.

FIG. 6 is an example diagram of a tracking-based region of interest (TR) obtained through the process of determining a region of interest for each cluster after cluster detection.

FIG. 7 is a diagram illustrating an object-centered region of interest estimation unit.

FIG. 8 is a diagram illustrating a method of operating a multi-object tracking unit.

FIG. 9 is a diagram illustrating a method of operating a single-object tracking unit.

FIG. 10 is a diagram illustrating a method of automatically extracting a region of interest from a captured high-resolution image according to a resolution and screen ratio of a display device.

FIG. 11 is a diagram illustrating a method for extracting a region of interest.

FIG. 12 is a diagram illustrating a process of estimating the final region of interest for all frames.

### BEST MODE

Hereinafter, with reference to the attached drawings, embodiments of the present disclosure will be described in detail so that those skilled in the art may easily practice them. However, the present disclosure may be implemented in many different forms and is not limited to the embodiments described herein.

In describing embodiments of the present disclosure, if it is determined that detailed descriptions of known configurations or functions may obscure the gist of the present disclosure, detailed descriptions thereof will be omitted. In addition, in the drawings, parts that are not related to the description of the present disclosure are omitted, and similar parts are given similar reference numerals.

In the present disclosure, when a component is said to be “connected,” “coupled,” or “combined” to another component, this may include not only a direct connection relationship, but also an indirect connection relationship in which another component exists in between. In addition, when a component is said to “include” or “have” another component, this does not mean that other components are excluded, but that other components may be further included, unless specifically stated to the contrary.

In the present disclosure, terms such as first and second are used only for the purpose of distinguishing one component from other components, and do not limit the order or importance of the components unless specifically mentioned. Accordingly, within the scope of the present disclosure, a first component in one embodiment may be referred to as a second component in another embodiment, and similarly, the second component in one embodiment may be referred to as the first component in another embodiment.

In the present disclosure, distinct components are intended to clearly explain each feature, and do not necessarily mean that the components are separated. That is, a plurality of components may be integrated to form one hardware or software unit, or one component may be distributed to form a plurality of hardware or software units. Accordingly, even if not specifically mentioned, such integrated or distributed embodiments are also included in the scope of the present disclosure.

In the present disclosure, components described in various embodiments do not necessarily mean essential components, and some may be optional components. Accordingly, embodiments consisting of a subset of the elements described in one embodiment are also included in the scope of the present disclosure. Additionally, embodiments that include other components in addition to the components described in the various embodiments are also included in the scope of the present disclosure.

In the present disclosure, a tracking-based region of interest (TR) refers to an initial region of interest calculated based on a multiple-object or single-object tracking technique, and the tracking-based region of interest (TR) may be calculated only for selected frames. The final region of interest (FR) refers to the final region of interest delivered to a viewer terminal, and one or more final regions of interest may be output for each frame.

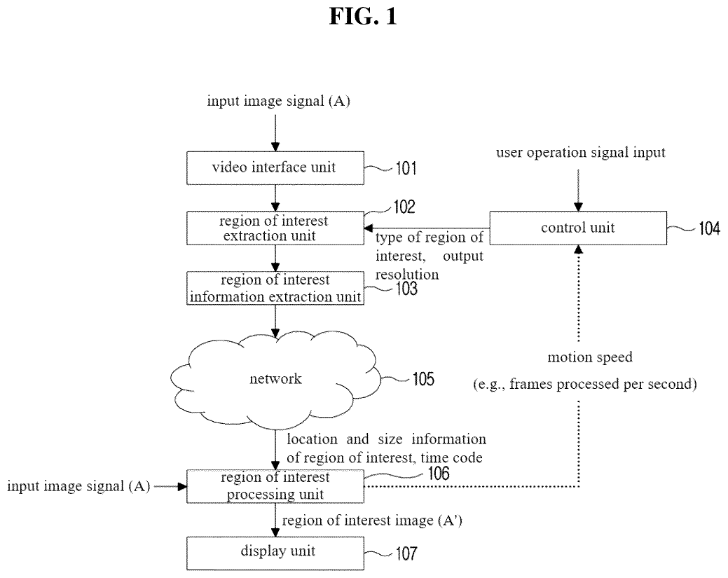

FIG. 1 is a diagram illustrating a device that automatically extracts a region of interest from a captured high-resolution image according to a resolution and screen ratio of a display device.

As shown in FIG. 1, a device for automatically extracting a region of interest in real time according to the present disclosure may include at least one of a video interface unit 101, a region of interest extraction unit 102, a region of interest information extraction unit 103, a control unit 104, a network 105, a region of interest processing unit 106, or a display unit 107.

A video interface unit 101 may receive high-resolution images obtained from imaging equipment, etc., and transmit an input images to a region of interest extraction unit 102.

A region of interest information output unit 103 may transmit unique information on an extracted region of interest to a viewer terminal through a network 105. The unique information of the region of interest may be the size (width, height, size, etc.) and location information of the region of interest, and the region of interest information may be packetized in accordance with communication standards and transmitted to the viewer terminal. As an example of a packetization process of region of interest information, region of interest information may be transmitted through TCP (Transmission Control Protocol) socket transmission, and one packet may include a location, width, and height of the top-left pixel of a region of interest in one frame.

A region of interest processing unit 106 may receive an original input image and region of interest information, and may crop a region of interest in the high-resolution image. In addition, a region of interest processing unit may resize a region of interest to match a display resolution because a screen ratio of a region of interest and a screen ratio of a display may be identical, but a resolution of a region of interest and a resolution of a display resolution may be different.

A display unit 107 may display a region of interest cropped and resized by a region of interest processing unit 106 on the screen.

In the real-time automatic region of interest extraction apparatus of the present disclosure, an user may select either a cluster-centered region of interest or an object-centered region of interest according to image characteristics. In addition, the real-time automatic region of interest extraction device of the present disclosure may be configured to extract a region of interest by considering both cases where a viewer directly designates an object or region of interest and cases where a viewer does not designate an object or region of interest when extracting a region of interest. Selection of the region of interest and designation of the region of interest may be performed by transmitting a signal from an user terminal to a control unit 104 of the device for automatically extracting the region of interest in real time through a network.

A control unit 104 may receive an user manipulation signal and directly control the operation of the region of interest extractor 102. For example, if there is a signal from an user to change a type of a region of interest during real-time broadcasting, a control unit may change the type of the region of interest from a cluster-centered region of interest to an object-centered region of interest. Additionally, a control unit may change a type of a region of interest from an object-centered region of interest to a cluster-centered region of interest according to contents of the signal.

A control unit 104 may control a performance speed of a region of interest extractor 102 by analyzing an user manipulation signal and a current system operation signal, and changing a tracking-based region of interest (TR) calculation cycle. The period may be determined in units of frames or seconds, and may be determined automatically by referring to information (frame information, etc.) stored in metadata of an image.

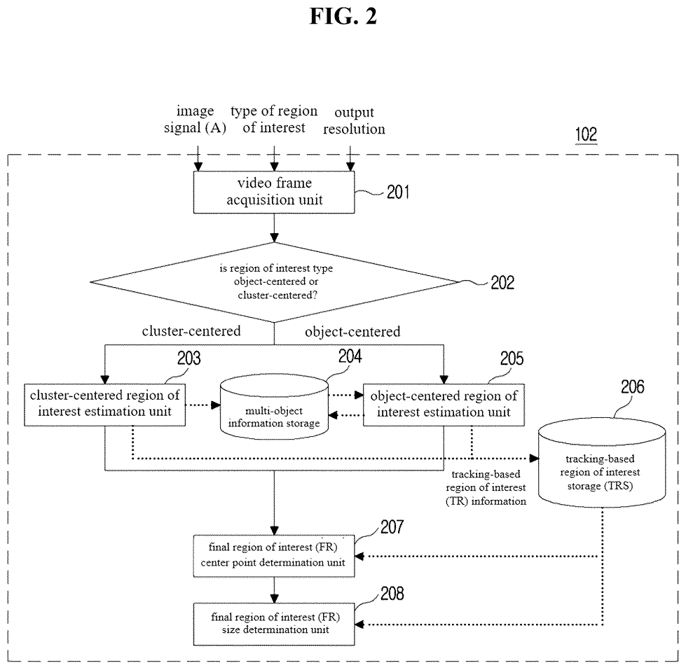

FIG. 2 is a diagram illustrating a region of interest extraction unit.

A region of interest extraction unit 102 of the present disclosure may include at least one of a video frame acquisition unit 201, a cluster-centered region of interest estimation unit 203, a multi-object information storage 204, an object-centered region of interest estimation unit 205, a final region of interest center point determination unit 207, or a final region of interest size determination unit 208. A region of interest extraction unit 102 of the present disclosure may further include a tracking-based region of interest storage (TRS, 206) in addition to the above components, and in some cases, a tracking-based region of interest storage 206 may be located outside a region of interest extraction unit 102. In the present disclosure, a cluster-centered region of interest estimation unit 203 and an object-centered region of interest estimation unit 205 may be collectively referred to as a region of interest estimation unit. In the present disclosure, a final region of interest center point determination unit 207 and a final region of interest size determination unit 208 may be collectively referred to as a final region of interest determination unit.

A video frame acquisition unit 201 may deliver video frames in an order of playback or encoding/decoding of an input video. Additionally, a video frame acquisition unit 201 may check whether a type of region of interest is object-centered or cluster-centered based on a signal received from a control unit 104 (202). When a type of a region of interest is a cluster-center region of interest, a video frame acquisition unit 201 may transmit a video frame to a cluster-center region of interest estimation unit 203. In contrast, when a type of region of interest is an object-centered region of interest, a video frame acquisition unit 201 may transmit a video frame to an object-centered region of interest estimation unit 205.

A cluster-centered region of interest estimation unit 203 may calculate a tracking-based region of interest (TR) by applying multi-object tracking (MOT) based on a received video frame. And, a multi-object tracking result may be delivered to and stored in a multi-object information storage 204.

A object-centered region of interest estimation unit 205 may calculate a tracking-based region of interest (TR) by applying a single-object tracking technique (SOT) based on a received video frame. The single-object tracking may be performed with reference to multiple object tracking results received from a multiple object information storage 204.

A tracking-based region of interest storage (TRS) 206 may store tracking-based region of interest (TR) information obtained from a cluster-centered region of interest estimation unit 203 or an object-centered region of interest estimation unit 205. A tracking-based region of interest data most recently stored in a storage may be used to calculate a final region of interest (FR) of a current frame.

A final region of interest (FR) center point determination unit 207 may determine a center point of a final region of interest of a current frame so that it gradually resembles a center point of the most recent tracking-based region of interest (TR) while considering movement paths of center points of final regions of interest (FR) of previous frames. In one embodiment, a center point of a final region of interest of a current frame may be determined as an average vector of vectors connecting center points of previous frames. As an example when considering three previous frames, a position of a center point of a current frame may be determined by applying an average vector obtained by averaging a first vector connecting a center point of the second previous frame from a center point of the first previous frame and a second vector connecting a center point of the third previous frame from a center point of the second previous frame to a center point of the third previous frame.

A final region of interest size determination unit 208 may determine a width and height of a final region of interest of a current frame so that it gradually resembles a width and height of the most recent tracking-based region of interest (TR) while considering widths and heights of final regions of interest (FR) of previous frames. In one embodiment, a width and height of a final region of interest of a current frame may be determined as an average value of widths and heights of the final regions of interest of previous frames. The average value may include a weighted average value, and a weight of the weighted average value may be determined by the frame interval between a current frame and previous frames (The farther away, the less weight it may have).

In summary, a final region of interest (FR) of a current frame may be completely determined by a final region of interest center point determination unit 207 and a final region of interest size determination unit 208.

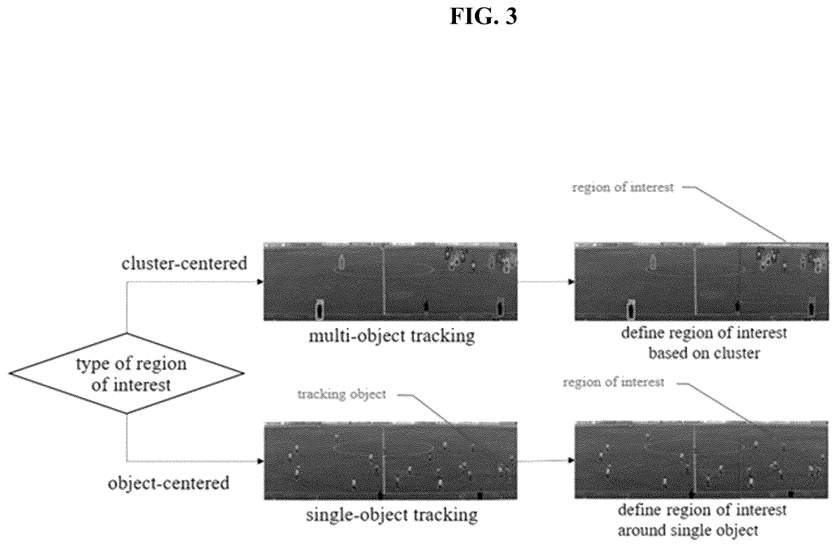

FIG. 3 is a diagram illustrating an embodiment according to the process of FIG. 2.

FIG. 3 illustrates examples of results when a type of a region of interest of a current frame is a ‘cluster-centered’ region of interest and an ‘object-centered’ region of interest. A rectangular region in right photos of FIG. 3 may represent a region of interest. Depending on a feature of a content, a type of a region of interest may be selected as either ‘object-centered’ or ‘cluster-centered’. For example, when there are many small objects over a large stadium, such as a soccer video, choosing a ‘crowd-centered’ region of interest may be appropriate. As another example, in the case of a one-person broadcast, it may be appropriate to select an ‘object-centered’ region of interest. In addition, even when a number and size of objects change rapidly during a broadcast, a viewer may watch an appropriate region of interest by alternating between a cluster-centered region of interest and an object-centered region of interest. In addition, depending on a number of objects displayed in an image, a type of a region of interest may be automatically selected as either ‘object-centered’ or ‘cluster-centered’. For example, when a number of objects displayed in an image is equal to or less than a threshold value of 3, a type of a region of interest may be selected as object-centered, but when a number of objects displayed in an image exceeds the threshold value of 3, a type of a region of interest may be selected as cluster-centered.

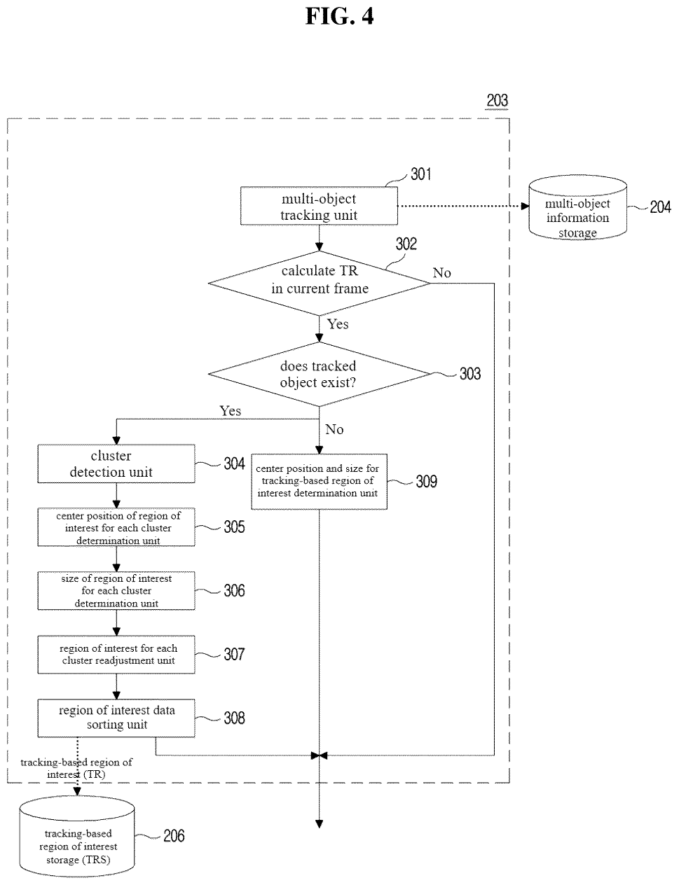

FIG. 4 is a diagram illustrating a cluster-centered region of interest estimation unit.

A cluster-centered region of interest estimation unit 203 may include at least one of a multi-object tracking unit 301, cluster detection unit 304, a center position of region of interest for each cluster determination unit 305, a size of region of interest for each cluster determination unit 306, a region of interest for each cluster readjustment unit 307, a region of interest data sorting unit 308, or a center position and size for the tracking-based region of interest determination unit 309. A cluster-centered region of interest estimation unit 203 of the present disclosure may further include a multi-object information storage 204 in addition to the above components, and in some cases, the multi-object information storage 204 may be located outside the cluster-centric region of interest estimation unit 203.

As the first process of a cluster-centered region of interest estimation unit 203, a multi-object tracking unit 301 may perform multiple object tracking (MOT) on a current frame. A result of the multiple object tracking may be transmitted to a multi-object information storage 204.

Subsequently, a multi-object tracking unit 301 may check whether to omit a process of calculating a tracking-based region of interest (TR) in a current frame (302). Whether to omit a process of calculating tracking-based region of interest (TR) may be determined by reading a signal from a control unit 104 or according to a predefined TR calculation cycle rule. If a process of calculating a tracking-based region of interest (TR) is omitted in a current frame, a subsequent process for finding a tracking-based region of interest (TR) may be omitted and a process of calculating a final region of interest (FR) may be performed immediately (207). In the case of calculating a tracking-based region of interest (TR) in a current frame, a multi-object tracking unit 301 may check whether there is more than one tracked object as a result of multi-object tracking (303).

When calculating a tracking-based region of interest (TR) in a current frame (302) and a tracked object does not exist (303), a center position and size of a tracking-based region of interest determination unit 309 may immediately determine the center position and size of a tracking-based region of interest (TR) according to predefined rules. For example, a center position of an input image may be set to a center position of a tracking-based region of interest (TR), and a width and height may be set to correspond to an output resolution.

When calculating a tracking-based region of interest (TR) in a current frame (302) and there is at least one tracked object (303), a cluster detection unit 304 may consider a position of objects obtained as a result of multi-object tracking as two-dimensional point data and cluster point data in a two-dimensional space. When clustering, an initial cluster radius may be set considering a resolution of an output display. When clusters are obtained in the above process, a tracking-based region of interest (TR) may be created for each cluster.

A center position of the region of interest for each cluster determination unit 305 may determine a center position of a region of interest for each cluster (305). For example, a center point of a region of interest may be set as an average position or median value of objects included in a cluster.

Subsequently, when a center position of a region of interest for each cluster determination unit 305 determines a center position of a tracking-based region of interest (TR), a size of a region of interest for each cluster determination unit 306 may determine at least one of a width or height of a tracking-based region of interest (TR). For example, a width and height may be initially set to a radius of a current cluster from a center point, and a width and height of a tracking-based region of interest (TR) may be readjusted so that bounding boxes of objects included in a current cluster are completely contained within a tracking-based region of interest (TR).

A region of interest for each cluster readjustment unit 307 may readjust at least one of a center point, a width, or a height of a tracking-based region of interest (TR) within a valid region within an entire image to suit a screen ratio of an output display.

As a result of the above processes, at least one tracking-based region of interest (TR) may be derived for each cluster. As an example, as a result of the above processes, a tracking-based region of interest may be derived for each cluster, and thus at least one tracking-based region of interest may be derived for each frame.

A region of interest data sorting unit 308 may sort a tracking-based region of interest (TR) with a large number of objects included in the cluster so that it comes first. In other words, tracking-based regions of interest may be sorted according to the number of objects included in a cluster. As an example, a 0-th tracking-based region of interest (TR) may be a region of interest containing the most objects. At this time, only one final region of interest (FR) may be calculated based on one 0-th tracking-based region of interest (TR), and a final region of interest (FR) may be created equal to the number of output tracking-based regions of interest (TR).

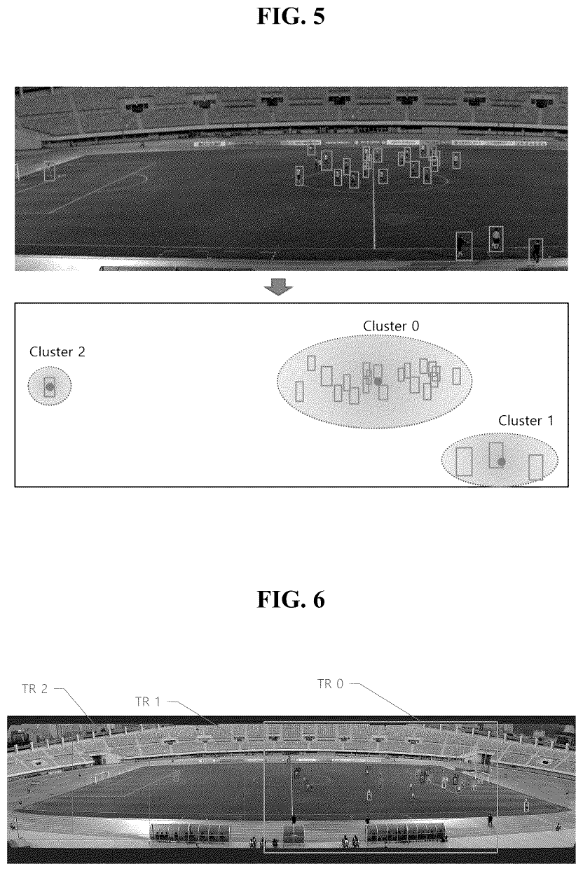

FIG. 5 is an example diagram of a result of clustering multiple objects in a cluster detection unit.

When there is more than one object in an image, one or more clusters may be obtained as a result of a cluster detection unit 304, and a tracking-based region of interest (TR) for each cluster may be defined through a subsequent process.

FIG. 6 is an example diagram of a tracking-based region of interest (TR) obtained through the process of determining a region of interest for each cluster after cluster detection.

In FIG. 6, there is more than one tracking-based region of interest (TR) and is indicated by a rectangular line. In particular, a 0-th tracking-based region of interest (TR 0) corresponding to a cluster containing the most objects is indicated by the thickest line.

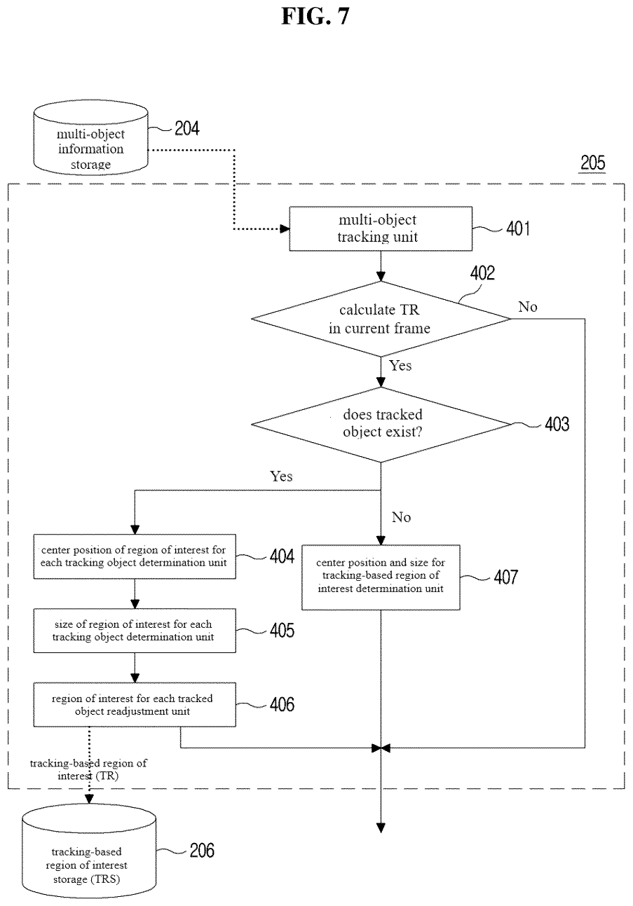

FIG. 7 is a diagram illustrating an object-centered region of interest estimation unit.

As shown in FIG. 7, an object-centered region of interest estimation unit 205 may include at least one of a single-object tracking unit 401, a center position of the region of interest for each tracking object determination unit 404, a size of the region of interest for each tracking object determination unit 405, a region of interest for each tracked object readjustment unit 406, or a center location and size of tracking-based region of interest determination unit 407. In addition, a region of interest extraction unit 102 of the present disclosure may further include a tracking-based region of interest storage (TRS, 206) in addition to the above components, and in some cases, a tracking-based region of interest storage 206 may be located outside a region of interest extraction unit 102.

An object-centered region of interest estimation unit 205 may utilize a single-object tracking technique (SOT) to calculate a tracking-based region of interest (TR).

A single-object tracking unit 401 may determine a object to be tracked in an initialization frame. At this time, a object to be tracked may be designated by an user or may be automatically designated without user designation. In addition, the single-object tracking unit 401 may refer to multi-object tracking results stored in a multi-object information storage 204 when automatically specifying an object to track.

After an object to be tracked is determined, a single-object tracking unit 401 may continuously track a designated object in all frames. Subsequently, a single-object tracking unit 401 may check whether to omit a process of calculating a tracking-based region of interest (TR) in the current frame (402). Whether to omit a process of calculating tracking-based region of interest (TR) may be determined by reading a signal from a control unit 104 or based on a predefined TR calculation cycle rule.

When a process of calculating a tracking-based region of interest (TR) is omitted in a current frame, subsequent processes for finding a tracking-based region of interest (TR) may be omitted and calculation of a final region of interest (FR) may be performed immediately.

In the case of calculating a tracking-based region of interest (TR) in a current frame, it is possible to check whether there is more than one object tracked in a single-object tracking unit 401 (403). When a tracked object does not exist, a center position and size of a tracking-based region of interest (TR) determination unit 407 may immediately determine a center position and size of a tracking-based region of interest (TR) according to predefined rules. For example, a center position of an input image may be set to a center position of a tracking-based region of interest (TR), and a width and height may be set to correspond to an output resolution.

When a tracking object is also present while calculating a tracking-based region of interest (TR) in a current frame, a center position of a region of interest for each tracked object determination unit 404 may calculate a center point of a tracking-based region of interest (TR) based on a location and size of a tracked object obtained as a result of single-object tracking. For example, a center point of a region of interest may be determined as a center position of a bounding box of a tracking object.

Once a center position of a tracking-based region of interest (TR) is determined, a size of a region of interest for each tracking object determination unit 405 may initially set a width and height of a tracking-based region of interest (TR) based on a tracking object size and display resolution.

A region of interest for each tracking object readjustment unit 406 may readjust a width and height within a valid region within an entire image to match a screen ratio of a output display. After the above processes are completed, a tracking-based region (TR) may be finally determined and stored in a tracking-based region of interest storage (TRS, 206).

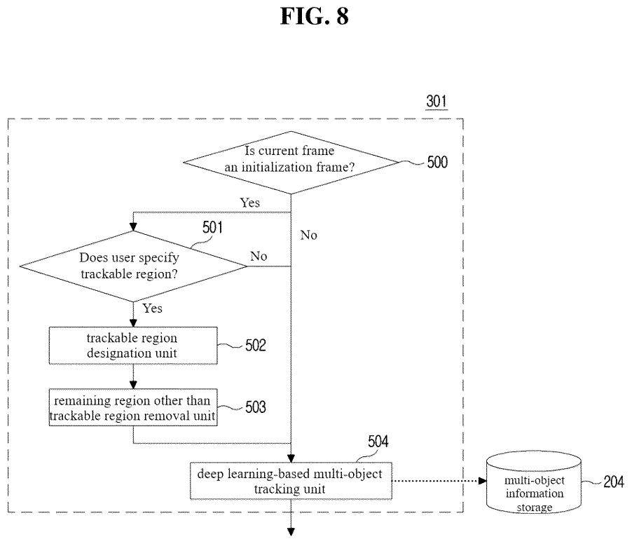

FIG. 8 is a diagram illustrating a method of operating a multi-object tracking unit.

As shown in FIG. 8, when a type of region of interest is cluster-centered, a partial region within an input image may be selected according to user preference, and the selected region may be set as a ‘trackable region’. In this disclosure, a region to which a multi-object tracking function is applied is referred to as the ‘trackable region’. Objects may not be detected in a region other than the trackable region.

When an user's signal to designate a trackable region is transmitted through a control unit 104 (501), a trackable region designation unit 502 may designate a trackable region in an initialization frame. For example, an user may designate a rectangular trackable region by dragging a mouse. As another example, an user may select multiple points with a mouse to designate a polygon-shaped trackable region.

Once a trackable region is determined, a remaining region removal unit 503 may exclude a remaining region other than a trackable region from an input image. The initialization frame may refer to the first frame of a frame sequence or the first frame input after a type of a region of interest is changed. When an user does not specify a trackable region, a trackable region may be an entire input image.

Once a trackable region is determined in an initialization frame, a deep learning-based multi-object tracking unit 504 may perform a deep learning-based real-time multi-object tracking process for all subsequent frames. As a result of multi-object tracking, location and size information of multiple objects may be obtained. And, a result of multi-object tracking is stored in a multi-object information storage 204, and multi-object tracking information 204 may be referenced in the automatic tracking object designation unit 604 of a single object tracking process 401.

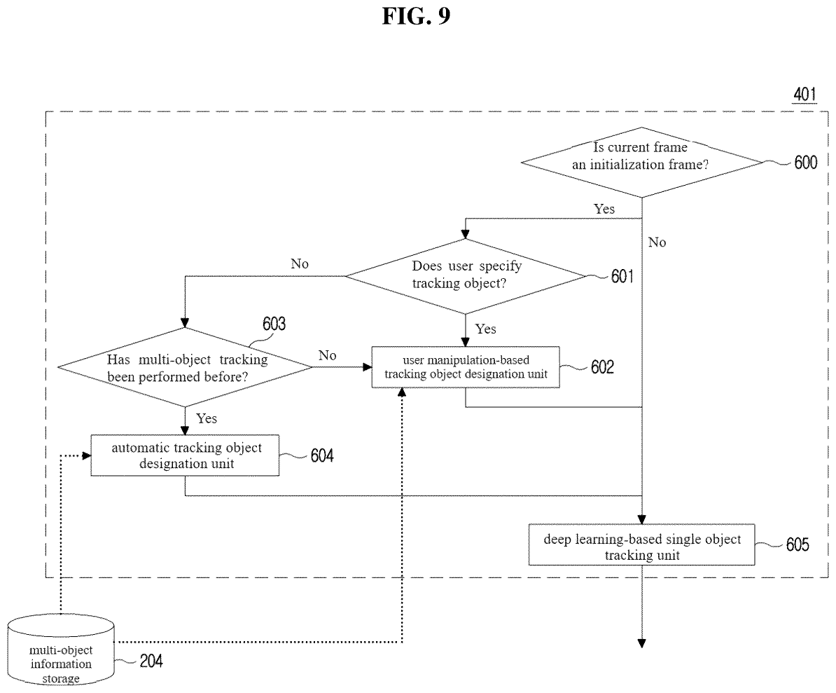

FIG. 9 is a diagram illustrating a method of operating a single-object tracking unit.

As shown in FIG. 9, when a region of interest is calculated centered on a single object in the present invention, a tracking object may be directly designated by an user or automatically selected. Selecting of a tracking object is carried out in an initialization frame, and a selected object may be continuously tracked in all frames including an initialization frame. In addition, a region of interest (TR) centered on a tracked object may be output based on a tracking result. In addition, automatic selection of single object tracking may be performed by referring to a result of multi-object tracking stored in a multi-object information storage 204.

When an user's signal for directly designating a tracking object is transmitted through a control unit 104 (601), an user manipulation-based tracking object designation unit 602 may designate a object to be tracked in an initialization frame. As an example, an user may specify a boundary of a single object by dragging a mouse. An user may also specify one (and more than one) object to be tracked. In this case, a corresponding tracking-based region of interest (TR) is created for each object, and as many tracking-based regions of interest (TR) as the number of selected objects may be output as a result.

When an user does not separately select a tracking object, it may be checked (603) whether there is data stored in a multi-object information storage 204.

When there is a result of multi-object tracking in the multi-object information storage 204, an automatic tracking object designation unit 604 may find the most important object among the stored multiple objects and designate it as a tracking object of a single object tracking unit. For example, among multiple previously tracked objects, an object with the largest amount of inter-frame movement may be designated as a tracking object. As another example, an object with the largest size among multiple detected objects may be designated as a tracking object.

When there is no multi-object tracking result in a multi-object information storage 204, an user manipulation-based tracking object designation unit 602 may allow an user to designate a tracking object. When a tracking object is specified in an initialization frame, a deep learning-based single object tracking unit 605 may track a selected object using a deep learning-based single-object tracking technique in all frames after an initialization frame. Then, a tracking-based region of interest (TR) may be determined based on a tracking result (205).

A cluster-centered region of interest estimation unit 203 and an object-centered region of interest estimation unit 205 may calculate a tracking-based region of interest (TR) within frames that satisfy a conditional statement 302 of FIG. 4 and a conditional statement 402 of FIG. 7, respectively. To reduce complexity for real-time region of interest estimation and provide visual comfort to viewers, a tracking-based region of interest (TR) acquisition process may be performed only in some frames of the entire sequence. Depending on a frequency of TR calculation frames, an execution speed and movement speed of the region of interest may be adjusted. A control unit 104 may detect a current system operation speed and user manipulation signals, and adjust a frequency of TR calculation frames. If no separate signal is received from a control unit 104, a frequency of TR calculation frames may be determined according to a predefined TR calculation cycle rule.

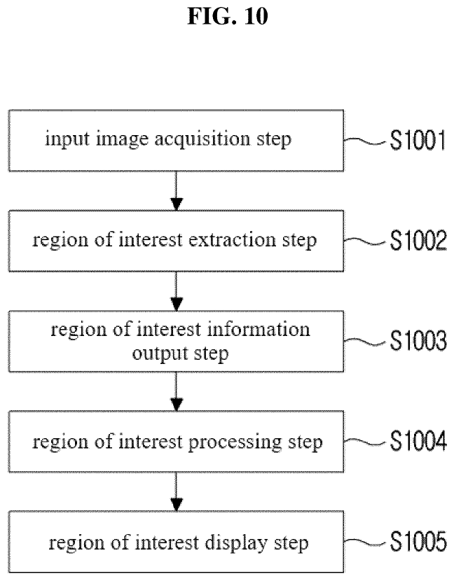

FIG. 10 is a diagram illustrating a method of automatically extracting a region of interest from a captured high-resolution image according to a resolution and screen ratio of a display device.

Referring to FIG. 10, a real-time automatic region of interest extraction method of the present disclosure may include at least one of an input image acquisition step (S1001), a region of interest extraction step (S1002), a region of interest information output step (S1003), a region of interest processing step (S1004), or a region of interest display step (S1005). The specific details of each step, as described in the real-time automatic region of interest extraction device of the present disclosure, are briefly summarized below.

In an input image acquisition step (S1001), a high-resolution image obtained from imaging equipment, etc. may be input and transmitted to a region of interest extraction unit. In a region of interest extraction step (S1002), a region of interest within an high-resolution input image may be extracted in real time in units of frames or seconds. In a region-of-interest information output step (S1003), unique information on a extracted region of interest may be transmitted to a viewer terminal through a network 105. In a region of interest processing step (S1004), an original input image and region of interest information are received, a region of interest in the high-resolution image is cut out, and a resolution of the region of interest may be resized to match a display resolution. In a region of interest display step (S1005), a region of interest cropped and resized in a region of interest processing step may be displayed on a screen.

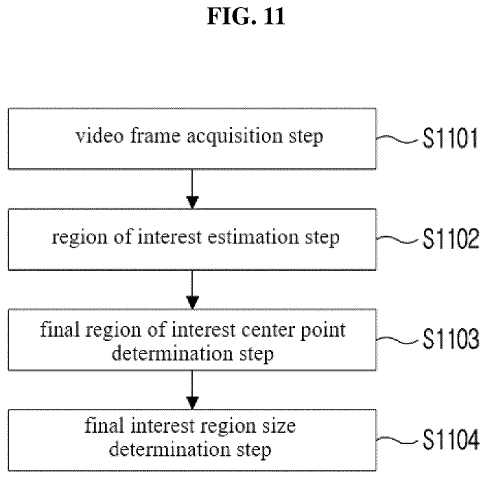

FIG. 11 is a diagram illustrating a method for extracting a region of interest.

A region of interest extraction step (S1002) of a real-time automatic region of interest extraction method of the present disclosure may include at least one of a video frame acquisition step (S1101), a region of interest estimation step (S1102), a final region of interest center point determination step (S1103), or a final interest region size determination step (S1104).

In a video frame acquisition step (S1101), video frames may be delivered in an order of playback or encoding/decoding of an input video. In addition, based on a signal received from a control unit 104, it may be confirmed whether a type of region of interest is object-centered or cluster-centered.

In a region of interest estimation step (S1102), when a type of region of interest is a cluster-centered region of interest, based on a received video frame, a tracking-based region of interest (TR) may be calculated by applying Multi Object Tracking (MOT).

Alternatively, in a region of interest estimation step (S1102), when a type of region of interest is an object-centered region of interest, based on a received video frame, a tracking-based region of interest (TR) may be calculated by applying single-object tracking (SOT).

In the final region of interest center point determination step (S1103), a center point of a final region of interest (FR) of a current frame may be determined to gradually resemble a center point of the most recent tracking-based region of interest (TR) while considering a movement path of a center point of a final region of interest (FR) of previous frames.

In a final region of interest size determination step (S1104), a width and height of a final region of interest (FR) of a current frame may be determined to gradually resemble a width and height of the most recent tracking-based region of interest (TR), while considering the width and height of the final region of interest (FR) of previous frames.

In summary, a final region of interest (FR) of a current frame may be completely determined by a final region of interest center point determination step (S1103) and a final interest region size determination step (S1104).

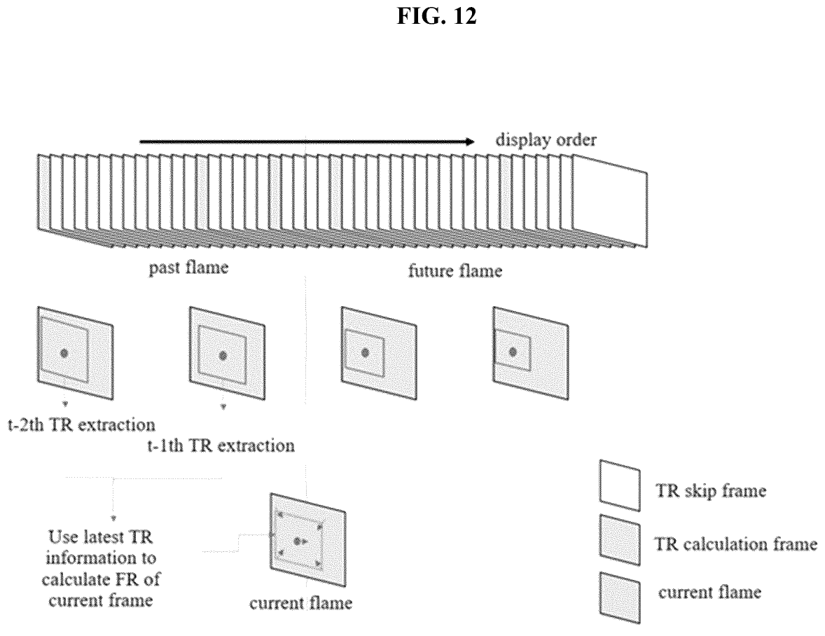

FIG. 12 is a diagram illustrating a process of estimating the final region of interest for all frames.

In FIG. 12, a white frame may be defined as a TR skip frame, a light blue frame may be defined as a TR calculation frame, and a yellow frame may be defined as a current frame. As shown in FIG. 12, a TR calculation frame corresponds to a portion of an entire frame sequence, and a TR calculation frame may be repeated at a uniform cycle. In a TR calculation frame, a tracking-based region of interest (TR) centered on a cluster/object may be estimated based on multiple/single tracking information obtained after a multiple/single-object tracking technique (301/401) is applied. In a TR skip frame, a process of calculating a tracking-based region of interest (TR) may be omitted.

When a tracking-based region of interest (TR) is obtained from every frame and is immediately output as a final region of interest (FR), the amount of movement or size change between frames of a region of interest may be very large, which may increase visual discomfort for viewers watching a final region of interest (FR). Therefore, in the present disclosure, a tracking-based region of interest (TR) is calculated only in some frames, and based on an accumulated tracking-based region of interest (TR) information, a final region of interest (FR) of a current frame may be calculated to gradually change from a previous frame. Through corresponding omission devices 302 and 402, a visually stable final region of interest may be estimated while controlling a complexity of calculating a region of interest.

To extract a final region of interest (FR), a center point of a final region of interest (FR) may first be calculated (207). A center point of a final region of interest (FR) resembles a center point of a tracking-based region of interest (TR) of the most recent frame, but may be prevented from moving sharply from a center point of a final region of interest (FR) of an immediately previous frame (207). As an example of a method for calculating a center point of a final region of interest, a curve (trajectory of movement of the center point) that approximately connects two-dimensional center points of tracking-based regions of interest (TR) may be calculated through a curve fitting method. A point located on a calculated curve may be set as a center point of a final region of interest (FR) of a current frame. Through this process, a center point of a final region of interest (FR) may move in a gentle movement trajectory, and visual fatigue felt by viewers watching a final region of interest may also be reduced. Once a center point of a final region of interest (FR) is fixed (207), a width and height of a current region of interest may be calculated to gradually resemble a width and height of the most recent tracking-based region of interest (TR) (208). Likewise, it is possible to avoid sudden changes in a width and height of a final region of interest (FR) of an immediately previous frame and output a visually stable final region of interest.

Above, the present invention has described an integrated system that outputs a region of interest according to the output resolution. The proposed method may select an object-centered interest region and a cluster-centered interest region according to broadcast content characteristics during the region of interest estimation process. In addition, to reduce visual discomfort, a method of extracting a region of interest that allows real-time operation while minimizing rapid movement and size changes of the region of interest was explained.

The method for extracting qualitative characteristics of an image according to an embodiment of the present disclosure may be implemented as a computer-readable recording medium including program instructions for performing various computer-implemented operations. The computer-readable recording medium may include program instructions, local data files, local data structures, etc., singly or in combination. The recording media may be those specifically designed and constructed for the embodiments of the present disclosure, or may be known and usable by those skilled in the art of computer software. Examples of computer-readable recording media include a magnetic media such as hard disks, floppy disks, and magnetic tapes, an optical recording media such as CD-ROM and DVD, a magneto-optical media such as floptical disks, and a specially configured hardware device to store and perform program instructions, such as ROM, RAM, flash memory, etc. The recording medium may be a transmission medium such as an optical or metal line or waveguide containing a carrier wave that transmits signals specifying program commands, local data structures, etc. Examples of program instructions may include machine language code such as that created by a compiler, as well as high-level language code that can be executed by a computer using an interpreter, etc.

The above description is merely an illustrative explanation of the technical idea of the present disclosure, and those skilled in the art will be able to make various modifications and variations without departing from the essential characteristics of the present disclosure. In addition, the embodiments disclosed in the present disclosure are not intended to limit the technical idea of the present disclosure, but are for illustrative purposes, and the scope of the technical idea of the present disclosure is not limited by these embodiments. Therefore, the scope of protection of this disclosure should be interpreted in accordance with the claims below, and all technical ideas within the equivalent scope should be interpreted as being included in the scope of rights of this disclosure.

What is claimed is:

1. A region of interest extraction method comprising:
confirming whether a region of interest of a current frame is a cluster-centered region of interest or an object-centered region of interest;
extracting a tracking-based region of interest of the current frame according to a type of the region of interest; and
determining a final region of interest of the current frame based on the extracted tracking-based region of interest of the current frame,
wherein, in response to the type of the region of interest being confirmed as the cluster-centered region of interest, extracting the tracking-based region of interest is performed for each cluster comprised of multiple objects in the current frame, and
wherein, in response to the type of the region of interest being confirmed as the object-centered region of interest, extracting the tracking-based region of interest is performed based on a single object.

2. The method of claim 1,
wherein a center point of the final region of interest of the current frame is determined based on movement paths of center points of final regions of interest of previous frames of the current frame, and
wherein a width and height of the final region of interest of the current frame are determined based on widths and heights of the final regions of interest of the previous frames of the current frame.

3. The method of claim 1,
wherein a center point of the tracking-based region of interest extracted for each cluster is determined by an average position or median value of multiple objects in a cluster.

4. The method of claim 3,
wherein a width and height of the tracking-based region of interest extracted for each cluster are determined based on the center point and a radius of the cluster.

5. The method of claim 4,
wherein the determined width and height are adjusted to include all bounding boxes of the multiple objects in the cluster.

6. The method of claim 5,
wherein the radius of the cluster is set in consideration of an output resolution of an image including the current frame.

7. The method of claim 1,
wherein the single object is determined differently depending on a type of the current frame.

8. The method of claim 7,
wherein, in response to the current frame being an initialization frame, the single object is determined based on a user-specified signal or a result of multi-object tracking, and
wherein, in response to the current frame being a frame after the initialization frame, the single object is determined to be the single object determined in the initialization frame.

9. The method of claim 8,
wherein the initialization frame is a first frame of a frame sequence including the current frame or a first frame input after the type of the region of interest is changed.

10. The method of claim 9,
wherein the user-specified signal includes a signal that specifies a boundary of the single object through a mouse drag function.

11. The method of claim 10,
wherein a width and height of the tracking-based region of interest extracted based on the single object are set in consideration of an output resolution of an image including the current frame.

12. A region of interest extraction apparatus comprising:
a video frame acquisition unit that confirms whether a region of interest of a current frame is a cluster-centered region of interest or an object-centered region of interest;
a region of interest estimation unit that extracts a tracking-based region of interest of the current frame according to a type of the region of interest; and
a final region of interest determination unit that determines a final region of interest of the current frame based on the extracted tracking-based region of interest of the current frame,
wherein, in response to the type of the region of interest being confirmed as the cluster-centered region of interest, extracting the tracking-based region of interest is performed for each cluster comprised of multiple objects in the current frame, and
wherein, in response to the type of the region of interest being confirmed as the object-centered region of interest, extracting the tracking-based region of interest is performed based on a single object.

13. The apparatus of claim 12,
wherein a center point of the final region of interest of the current frame is determined based on movement paths of center points of final regions of interest of previous frames of the current frame, and
wherein a width and height of the final region of interest of the current frame are determined based on widths and heights of the final regions of interest of the previous frames of the current frame.

14. The apparatus of claim 12,
wherein a center point of the tracking-based region of interest extracted for each cluster is determined by an average position or median value of multiple objects in a cluster.

15. The apparatus of claim 14,
wherein a width and height of the tracking-based region of interest extracted for each cluster are determined based on the center point and a radius of the cluster.

16. The apparatus of claim 15,
wherein the determined width and height are adjusted to include all bounding boxes of the multiple objects in the cluster.

17. The apparatus of claim 16,
wherein the radius of the cluster is set in consideration of an output resolution of an image including the current frame.

18. The apparatus of claim 12,
wherein the single object is determined differently depending on a type of the current frame.

19. The apparatus of claim 18,
wherein, in response to the current frame being an initialization frame, the single object is determined based on a user-specified signal or a result of multi-object tracking, and
wherein, in response to the current frame being a frame after the initialization frame, the single object is determined to be the single object determined in the initialization frame.

20. A computer-readable recording medium on which a computer program for executing the method according to claim 1 on a computer is recorded.
